(19) United States
(12) Patent Application Publication
(10) Pub. No.: US 2026/0165344 A1
(43) Pub. Date: Jun. 18, 2026

(54) CHICKEN-SUBSTITUTE FOOD PRODUCTS

(71) Applicants: Yissum Research Development Company of the Hebrew University of Jerusalem Ltd., Jerusalem (IL); FUTURE MEAT TECHNOLOGIES LTD, Rehovot (IL)

(72) Inventors: Yaakov NAHMIAS, Shoresh (IL); Mohammad GHOSHEH, Jerusalem (IL); Anat HERSCOVICI, Kfar Hanagid (IL); Andres VOLOSCHIN, Kfar Saba (IL); Ariel RUDIK, Rehovot (IL); Idan SHAFRIR, Kfar Shmuel (IL); Zach SHIDLOVSKY, Reut (IL); Shirley BRENNER, Givatayim (IL)

(73) Assignees: Yissum Research Development Company of the Hebrew University of Jerusalem Ltd., Jerusalem (IL); FUTURE MEAT TECHNOLOGIES LTD, Rehovot (IL)

(21) Appl. No.: 18/992,653

(22) PCT Filed: Jul. 11, 2023
(86) PCT No.: PCT/IL2023/050719

§ 371 Date: Jan. 9, 2025

Related U.S. Application Data
(60) Provisional application No. 63/368,203, filed on Jul. 12, 2022.

(51) Int. Cl. A23J 3/22; A23J 3/04; A23J 3/16; A23J 3/26; A23L 27/21

(52) U.S. Cl. CPC A23J 3/227; A23J 3/04; A23J 3/16; A23J 3/26; A23L 27/215

(57) ABSTRACT

The technology provides poultry-like meat products and methods of their preparation.

### TECHNOLOGICAL FIELD

The invention generally contemplates chicken-analog food products and processes for their preparation.

### BACKGROUND OF THE INVENTION

Chicken is one of the most common types of animal meat consumed. It is low in fat and high in protein and is thus considered a healthy lean protein source. However, industrial production of chicken meat is associated with the transmission of animal borne pathogens, such as salmonella and avian influenza. In fact, in a recent study more than 20% of chicken meat sold in the United States was found to be contaminated with salmonella due to residual fecal matter. Worse, the widespread use of antibiotics to enhance the growth of animal meat leads to the development of antibiotic resistant bacteria strains.

Driven by the increase in the public awareness of personal health, the development of substitute edible products that include non-animal sourced components such as proteins and fibers has dramatically increased; yet, with limited success in mimicking the meat in its taste and texture. This difficulty remains substantially unresolved where chicken mimicking products are concerned. Thus, there is a need for non-animal protein chicken analogs that can facilitate large scale production and adoption of non-animal based edible products.

### GENERAL DESCRIPTION

Current approaches to producing poultry analogs rely on high moisture (40 to 60% water) extrusion, a process in which plant protein concentrate or isolate is heated to temperatures between 130 to 170° C., under high pressures. Such conditions cause the proteins to denature, while shear forces in the extrusion arrange the denatured protein. The proteins are arranged in sheets or anisotropic structures in which all fibers align in the same direction. The presence of high humidity conditions further supports or induces formation of a fibrous poultry analog in which the fibers entirely align in one direction. The anisotropic structure feels rubbery when cut perpendicularly to the direction of extrusion and rapidly degrades upon cooking, leading to a gummy mouth feel that does not resemble poultry meat in any way. In addition, the application of high temperatures leads to activation of the Maillard reaction and to lipid oxidation in the uncooked poultry analog.

The Maillard reaction, also known as non-enzymatic browning, is a process that occurs between reducing sugars and amino acids at temperatures above 100° C., optimally between 140 to 160° C. Lipid oxidation of monosaturated and polyunsaturated fatty acids present in meat occurs at temperature above 90 to 100° C. The untimely reactions produce chemical compounds that lead to product browning and off-flavors due to oxidation and an incomplete experience of meat grilling for customers. To control activation of the Maillard reaction and further control or limit lipid oxidation products, some poultry analogs remove reducing sugars, amino acids, and polyunsaturated fatty acids from their recipe. While this methodology avoids some of the unwanted reactions that may occur in the uncooked product and leads to a white product with no off-flavors, the removal of these materials that are susceptible to the Maillard reaction prevents Maillard reaction and lipid oxidation upon grilling by an end user or consumer, reducing final product quality and overall consumer experience.

The recapturing of the poultry aroma and flavor upon grilling is essential, but also presents a challenge. Current flavor mixtures predominantly use roasted yeast preparations and plant oils that have not provided adequate replacement. One of the main challenges is the presence of an artificial flavor that becomes dominant as the poultry meat analog cools. The inventors of the technology disclosed herein have produced a biomass or a raw material for use in forming or manufacturing poultry meat analogs, e.g., chicken meat analogs, that are isotropic, namely composed of fibers aligned in all directions (mainly along a main axis of the products, i.e., the direction of extrusion and also perpendicularly thereto), which do not degrade during cooking, and which display a flavor, an aroma and a color closely mimicking that of poultry meat products. As the combination of materials making up the biomass and the low temperature processing conditions employed in its conversion into the poultry-meat analog do not induce formation of Maillard reaction products in the uncooked products, the products of the invention are stable poultry meat analogs in a ready for cooking or grilling form that highly resemble the look and feel of a real poultry meat.

In most general terms, the technology disclosed herein is based on a material composition that allows manufacturing of uncooked poultry-like meat analogs under low thermal conditions. The uniquely selected composition and the low thermal conditions employed provide a poultry-like meat substitute that does not evolve Maillard reaction products until such a time when the uncooked product is cooked or grilled. A comparison between methods and products of the invention and methods and products of the art are schematically illustrated in FIGS. 1A-B. FIG. 1A shows a process of the art producing a product having anisotropic distribution of protein fibers, while FIG. 1B illustrates a process according to some embodiments of the invention.

In a first of its aspects, there is provided a material composition comprising non-animal derived arachidonic acid (ARA) and at least one Maillard reaction intensifier selected from isolated amino acids and reducing sugars. The material composition may comprise one or more additional ingredients and may be configured for use in manufacturing poultry-like food products, as further defined herein.

The material composition used according to the invention may be provided as a raw material or as a biomass which comprises protein fibers, textured and non-textured, and a plurality of material components, which upon cooking produce products with poultry-mimicking aroma and texture.

The invention further provides a biomass or material composition for use in manufacturing a poultry-like meat product, the biomass/composition comprising textured and untextured protein fibers, arachidonic acid, at least one isolated amino acid and at least one Maillard reaction intensifier, as defined herein. In some embodiments, the manufacturing is a low temperature manufacturing process, as defined herein.

Further provided is a biomass or a material composition for use in a low temperature manufacturing of a poultry-like, e.g., chicken-like or turkey-like, meat product, the biomass/composition comprising textured protein fibers, non-textured protein fibers, and a plurality of non-animal derived foodstuffs, e.g., vegetarian foodstuffs, selected from arachidonic acid, amino acids, carbohydrates, non-textured proteins and others, wherein the biomass is characterized by an isotropic distribution of the textured protein fibers.

The invention further provides a poultry-like, e.g., chicken-like or turkey-like, meat product comprising an isotropic distribution of protein fibers, e.g., textured protein fibers, wherein the meat product is of a composition configured to produce, upon cooking, at least two volatile compounds endowing said product with a poultry-mimicking aroma.

The invention further provides a poultry-like, e.g., chicken-like or turkey-like, meat product comprising an isotropic distribution of textured protein fibers, non-textured protein fibers and a plurality of non-animal derived foodstuffs, e.g., vegetarian foodstuffs, selected from arachidonic acid, amino acids, carbohydrates, non-textured proteins and others.

The biomass or material composition of the invention is a combination of textured protein fibers, non-textured protein fibers, and additional materials, as disclosed herein, which may be processed to provide a “poultry-like meat product” or a poultry substitute product or a poultry analog in a form of a ready-for-cooking form, in a form of an uncooked meat product, and in a form of cooked or grilled poultry-like meat product. Typically, the biomass/composition and the resulting poultry-like product comprises or consists of vegetarian ingredients or foodstuffs as well as cultured animal or fish cells. As described herein the biomass/composition is composed of or provided in a material combination that renders the product with suitable organoleptic attributes such as texture, springiness, chewiness, cohesiveness, extensibility, taste, fragrance and visuality, that resemble the organoleptic attributes of poultry meat. A biomass/composition used for manufacturing the poultry-like product, as well as the method used, provide a product that exhibits isotropic characteristics in which the protein fibers making up the product are oriented in all directions and are not substantially unidirectionally oriented.

The biomass/composition may be processed and formed to provide a product that mimics or resembles meat from any avian species used for human consumption. The poultry may be chicken, turkey, goose, duck and others. In some embodiments, the poultry-like food product is a chicken-like food product.

As noted herein, the biomass/composition and the resulting poultry-like product comprise vegetarian foodstuffs and other foodstuffs that are not derived from an animal source. Such foodstuffs include a non-animal derived arachidonic acid, amino acids, carbohydrates, textured plant or fungi proteins, non-textured proteins (e.g., protein isolates) and others. In some cases, a synergistic combination of arachidonic acid and 2-methyl-3-furanthiol is used. To achieve a poultry or chicken like aroma, presence of very small amounts of the two components may be needed. Generally speaking, in any product of the invention comprising arachidonic acid, alone or in combination with 2-methyl-3-furanthiol, as low an amount as between 0.05 and 10 ppm of arachidonic acid may be used, in some embodiments, in combination with 0.5 to 10 ppm of 2-methyl-3-furanthiol.

In some embodiments, the amount of arachidonic acid is between 0.05 and 1 or between 0.05 and 0.1 ppm, and the amount of 2-methyl-3-furanthiol is 0.5 to 1 ppm.

In some embodiments, the amount of arachidonic acid is 0.05 ppm or 1 ppm or 0.1 ppm, and the amount of 2-methyl-3-furanthiol is 0.5 or 1 ppm.

In some embodiments, a synergistic effect resides in a combination of arachidonic acid and 2-methyl-3-furanthiol provided at a weight ratio of 1:10 of arachidonic acid to 2-methyl-3-furanthiol. In some embodiments, the ratio arachidonic acid to 2-methyl-3-furanthiol is between 1:1 and 1:10, namely the ratio may be 1:10, 1:9, 1:8, 1:7, 1:6, 1:5, 1:4, 1:3, 1:2 or 1:1.

Thus, further provided is a biomass or a material composition and a poultry-like, e.g., chicken-like, meat product produced therefrom, comprising a synergistic combination of a non-animal derived arachidonic acid and 2-methyl-3-furanthiol, inducing a poultry-mimicking aroma to the food product. The synergistic combination comprises an amount of the two components, wherein the amount of each component is an amount (in ppm) which in the combination exhibits an effect that is greater than the effect exhibited by each of the two components when used alone at the same amount. The amount that defines the synergistic effect may alternatively be defined as a ratio amount between the two components in the combination. The synergistic effect or superiority of a combination and thus products of the invention is reflected in the perceptive aroma of poultry-like products of the invention, which may be determined, as explained herein, on an aroma score (by panel taste). As explained herein, while for example, an aroma score of products using each component separately may be indexed as 2 and 3, their combination would provide an aroma index that is greater than 9.

In some embodiments, the synergistic combination comprises an amount of arachidonic acid that is between 0.05 and 0.1 ppm and an amount of 2-methyl-3-furanthiol that is between 0.5 to 1 ppm.

In some embodiments, the synergistic amount is defined by a weight ratio in which the amount of 2-methyl-3-furanthiol is at least twice as large as the amount of arachidonic acid. In some embodiments, the ratio arachidonic acid to 2-methyl-3-furanthiol is between 1:2 and 1:10.

In some embodiments, the synergistic amount is defined by a weight ratio of 1:10 of arachidonic acid to 2-methyl-3-furanthiol.

The invention further provides a biomass or a material composition and a poultry-like, e.g., chicken-like, meat product produced therefrom, comprising at least one non-animal derived arachidonic acid, at least one amino acid, at least one carbohydrate, at least one textured plant or fungi protein and at least one non-textured protein. The product may further comprise one or more functional additives.

In some embodiments, the biomass or food product comprises textured protein, arachidonic acid, and 2-methyl-3-furanthiol. In some embodiments, the product comprises a synergistic combination of arachidonic acid 2-methyl-3-furanthiol, as defined herein.

In some embodiments, presence of 2-methyl-3-furanthiol may not be needed. Thus, a biomass or a material composition of the invention may not comprise or may be free of 2-methyl-3-furanthiol.

Arachidonic acid, ARA, is a polyunsaturated omega-6 fatty acid, cis-5,8,11,14-eicosatetraenoic acid. Also referred to as arachidonic acid (20:4), it is considered as an important constituent of biological membranes, a precursor of prostaglandins and many other eicosanoids. ARA is a major constituent of the brain phospholipid membrane, can act as an immune-suppressant, and induce inflammatory responses, blood clotting and cell signaling. Free ARA and its metabolites are important for the function of skeletal muscle and nervous system as well as the immune system for the resistance to allergies and parasites.

Many microbes including fungi, yeast and some bacteria have the ability to synthesize significant amounts of ARA. ARA may be obtained from lower plant species as well as from fungi or mushrooms, liverworts, mosses, hornworts, lycophytes, monilophytes, seagrasses and some higher terrestrial plants. In some embodiments, ARA used according to the invention may be derived from liverworts such as Conocephalum conicum, Marchantia polymorpha, Riccia fluitans, and others; mosses such as Marchantia polymorpha, Physcomitrella patens, Pottia lanceolata, Atrichum undulatum, Brachythecium rutabulum, Rhynchostegium murale, Mnium cuspidatum, Mnium medium, Hylocomium splendens, Pleurozium schreberi, Mnium hornum, Leptobryum pyriforme, Funaria hygrometrica, Polytrichum juniperinum, Hedwigia ciliate, Hylocomium splendens, and others; hornworts such as Anthoceros agrestis, Anthoceros punctatus, Phaeoceros laevis, and others; lycophytes such as Huperzia phlegmaria, and others; monilophyte such as Polypodium vulgare, Davallia canariensis, Tectaria zeylanica, Polystichum aculeatum, Onoclea sensibilis, Blechnum spicant, Thelypteris palustri, Gymnocarpium robertianum, Asplenium trichomanes, Adiantum venustum, Sphaeropteris cooperi, Salvinia natans, Salvinia molesta, Anemia phyllitidis, Lygodium volubile, Osmunda regalis, Angiopteris evecta, Equisetum trachyodon and others; seagrasses such as Cymodocea sp., Thalassia sp., Enhalus sp., Halodule sp, and others; higher terrestrial plants such as Agathis Araucana, beta maritima L. (wild beet), Cardaria draba L. (hoary cress), Chenopodium album L. (goosefoot), Chenopodium murale L. (goosefoot), Malva sylvestris L. (common mallow), Plantago major L. (plantain), Sisymbrium irio L. (hedge mustard), Sonchus tenerrimus L. (sow-thistle-of-the-wall), Stellaria media villars (chickweed), Verbena officinalis L. (vervain), Araucaria bidwillii, Araucaria cunninghamii, Araucaria araucana, Agathis robusta, Agathis araucana, Agathis dammara, Artemisia armeniaca, Artemisia incana, Artemisia tournefortiana, Artemisia hausknechtii, Artemisia scoparia, and others; fungi such as non-pathogenic fungi Mortierella spp, or M. alpina 1S-4 and ATCC 32,222.

ARA used in products of the invention (biomass, material composition or meat product, as defined) is a non-animal derived material, which may be derived from any of the above non-animal sources. In some embodiments, ARA is derived from a fungi or mushroom source. In some embodiments, ARA is provided as a mushroom oil having an enriched ARA concentration. In some embodiments, the ARA is arachidonic acid oil commercially available from Cargill (product code AOGC43A), optionally in a crude form.

In some embodiments, ARA is provided in a form of an oil derived from fungi, such as Mortierella alpina I₄₉-N₁₈.

In some embodiments, the amount of ARA-rich oil or material that is added to compositions of the invention is sufficient to provide ARA concentration in the composition or final product that is at least 0.05 ppm. Thus, depending on the source material rich in ARA and form of the material, e.g., solid, oil, solution, etc, as well as on the concentration of ARA in the source material used, the amount of the ARA-rich material may be tailored to provide a minimum ARA concentration of 0.05 ppm. In some embodiments, the amount is between 0.05 to 10 ppm. In some embodiments, the amount of ARA is between 0.05 and 9 ppm, 0.05 and 8 ppm, 0.05 and 7 ppm, 0.05 and 6 ppm, 0.05 and 5 ppm, 0.05 and 4 ppm, 0.05 and 3 ppm, 0.05 and 2 ppm, 0.05 and 1 ppm, 0.05 and 0.5 ppm, 0.05 and 0.1 ppm, 0.1 and 10 ppm, 0.1 and 9 ppm, 0.1 and 8 ppm, 0.1 and 7 ppm, 0.1 and 6 ppm, 0.1 and 5 ppm, 0.1 and 4 ppm, 0.1 and 3 ppm, 0.1 and 2 ppm, 0.1 and 1 ppm, 1 and 10 ppm, 2 and 9 ppm, 3 and 8 ppm, 4 and 7 ppm, 5 and 10 ppm, or between 5 and 9 ppm. In some embodiments, the amount of ARA is 0.05 ppm, 0.1 ppm, 0.15 ppm, 0.2 ppm, 0.25 ppm, 0.3 ppm, 0.35 ppm, 0.4 ppm, 0.45 ppm, 0.5 ppm, 0.55 ppm, 0.6 ppm, 0.65 ppm, 0.7 ppm, 0.75 ppm, 0.8 ppm, 0.85 ppm, 0.9 ppm, 0.95 ppm, 1 ppm, 2 ppm, 3 ppm, 4 ppm, 5 ppm, 6 ppm, 7 ppm, 8 ppm, 9 ppm, or 10 ppm.

The amino acids used in products of the invention are “isolated amino acids” namely amino acids which are added as such, not in a form of a naturally derived product inherently comprising same. The amino acids may be provided in either the L- or D-form or in a racemic form. Additionally or alternatively, the amino acids may be selected from essential, non-essential and conditional amino acids, as known in the art. Typically, the amino acid(s) utilized in products of the invention is one or more or a combination of amino acids selected from natural, synthetic or semi-synthetic sources. The amino acid may be alanine, arginine, asparagine, aspartate, cystine, cysteine, glutamine, glutamate, glycine, histidine, isoleucine, leucine, lysine, methionine, phenylalanine, proline, serine, threonine, tryptophan, tyrosine and valine. In some embodiments, the amino acid is cysteine, cystine, histidine, isoleucine, leucine, lysine, methionine, phenylalanine, threonine, tryptophan, and valine.

In some embodiments, the amino acid is selected amongst essential amino acids. Such may be any one or more of histidine, isoleucine, leucine, lysine, methionine, phenylalanine, threonine, tryptophan, and/or valine.

In some embodiments, the amino acid is selected amongst nonessential amino acids. Such may be any one or more of alanine, arginine, asparagine, aspartic acid, cysteine, glutamic acid, glutamine, glycine, proline, serine, and/or tyrosine.

In some embodiments, the amino acid is selected amongst conditional amino acids. Such may be any one or more of arginine, cysteine, glutamine, tyrosine, glycine, ornithine, proline, and/or serine.

In some embodiments, the biomass/composition or meat product comprises two or more amino acids or a blend or a combination of amino acids. In some embodiments, the amino acids are provided as short peptides such as di, tri, tetra or pentapeptides.

In some embodiments, the amino acid or combination of amino acids or peptides may comprise one or both of cysteine and lysine.

The amino acid(s) may be present in a final product (a biomass, composition, uncooked or cooked product) in an amount ranging from 0.01 mM to 30 mM. In some embodiments, the amount of cysteine is between 0.01 and 0.05 wt % and the amount of lysine is between 0.07 and 0.09 wt %.

In some embodiments, the amino acid(s) is used in combination with at least one carbohydrate at a weight ratio of 1:3 amino acid(s):carbohydrate. In some embodiments, the amino acid is cysteine and/or lysine and the ratio amino acid:carbohydrate is a ratio between an amount of cysteine and/or lysine to the carbohydrate. In some embodiments, the ratio is between a combined amount of cysteine and lysine to an amount of a carbohydrate such as ribose.

The carbohydrate used may be a natural material, a synthetic/biosynthetic material or a semisynthetic/semibiosynthetic material. The carbohydrate may be an unmodified carbohydrate such as a naturally occurring carbohydrate or a modified carbohydrate.

The carbohydrate may be a monosaccharide, a disaccharide, an oligosaccharide, or a polysaccharide. In some embodiments, the carbohydrate is selected from cyclic oligosaccharides, maltodextrins, beet oligosaccharides, isomaltooligosaccharides, xylooligosaccharides, xylo-terminated oligosaccharides, gentiooligosaccharides, fructooligosaccharides, maltooligosaccharides, soybean oligosaccharides and others. Non-limiting examples of carbohydrates include, without limitation, trehalose, galactose, rhamnose, sucrose, glucose, ribulose, fructose, threose, arabinose, xylose, lyxose, allose, altrose, mannose, idose, lactose, maltose, isotrehalose, neotrehalose, isomaltulose, erythrose, deoxyribose, gulose, idose, talose, erythrulose, xylulose, psicose, turanose, amylopectin, glucosamine, mannosamine, fucose, glucuronic acid, abequose, galactosamine, isomaltose, isomaltotriose, panose xylotriose, xylobiose, sorbose, maltotetraol, maltotriol, starch, inulin, raffinose, ribose, and others.

In some embodiments, the carbohydrate is ribose.

In some embodiments, the ribose is used in combination with amino acid(s) at a weight ratio of 1:3 amino acid(s):ribose. In some embodiments, the amino acid is cysteine and/or lysine and the ratio amino acid:ribose is a ratio between an amount of cysteine and/or lysine to ribose. In some embodiments, the ratio is between a combined amount of cysteine and lysine to an amount of ribose.

In some embodiments, the carbohydrate is a modified carbohydrate, such as a modified ribose. A modified carbohydrate is a carbohydrate that has been substituted or otherwise modified by addition, e.g., by substitution, or by including a structural change, e.g., removal, of one or more atoms or groups of atoms onto or from the carbohydrate skeleton. Modification may include substitution or de-substitution or deoxygenation. In some cases, modification involves addition or removal of an atom, e.g., H, C, O, N, halogens, or a group of atoms, e.g., comprising H, C, O, N or halogens; or a group selected from carboxyl, acyl, acyloxy, amino, amido, carboxyl groups, alkylamino, arylamino, alkoxy, aryloxy, nitro, cyano, sulfo, mercapto, sulfonyl, sulfenyl, sulfinyl, sulfamoyl, phosphor, phosphonyl, phosphinyl, phosphoryl, phosphino, thioester, thioether, carbamyl, and others.

In some embodiments, the carbohydrate is selected amongst reducing sugars. As known in the art, a reducing sugar is a carbohydrate that is oxidized by a weak oxidizing agent under basic aqueous conditions to generate one or more compounds containing an aldehyde group. As substantially most or all monosaccharides and disaccharides are reducing sugars, and some oligosaccharides and polysaccharides may be regarded such as well, in some compositions of products of the invention, the carbohydrate, selected as a reducing agent, may be selected amongst monosaccharides and disaccharides. In some embodiments, the reducing sugar may also be selected amongst oligosaccharides and polysaccharides.

In some embodiments, the reducing sugar is selected amongst monosaccharides. Examples include glucose (dextrose), fructose (levulose), galactose, xylose and ribose.

In some embodiments, the reducing sugar is a disaccharide selected from sucrose, lactose, and maltose.

Reducing sugars react with amino acids in the Maillard reaction, a series of reactions that occur while cooking food at high temperatures, and which determine the flavor of the food product. The Maillard reaction, referred to as a non-enzymatic browning, is a complex process which involves a reaction between a reducing sugar and proteins impacted by heat at temperatures above 100° C. The Maillard reaction starts with a reaction of a reducing sugar with an amine, creating glycosylamine, which subsequently undergo a reaction to produce a derivate of amino deoxy fructose. The reaction is continuous and very reactive intermediate substances are formed which subsequently react in several different ways. Eventually, a furan derivate is generated which reacts with other components to polymerize into a dark-colored insoluble material containing nitrogen. Sulphur-containing amino acids play a primary role in the formation of a flavor-intensive components generated during the Maillard reaction. The flavor which mimics that of a grilled chicken product contains heterocyclic compounds derived from amino acids, nucleotides and sugars from the Maillard reaction, including 2-methyl-3-furanthiol. Unsaturated fatty acids, such as ASA, further contribute to the formation of odorous heterocyclic flavor compounds during the Maillard reaction.

Thus, in some embodiments, the carbohydrate or reducing sugar used in products of the invention (biomass/composition or meat products) is a Maillard reaction intensifier or strengthener. In some embodiments, the carbohydrate that may be used as a Maillard reaction intensifier is selected from glucose, fructose, ribose, arabinose, glucose-6-phosphate, fructose-6-phosphate, fructose-1,6-diphosphate, inositol, maltose, sucrose, maltodextrin, glycogen, nucleotide bound sugars, molasses, honey, corn syrup, maple and agave syrup.

In some embodiments, the carbohydrate is a non-reducing sugar. As known in the art, non-reducing sugars do not have free ketone or aldehyde group. They are typically characterized as having an acetal in place of hemiacetal group. The non-reducing sugars do not participate in the Maillard reaction. Non-limiting examples of such non-reducing sugars include sucrose, trehalose, raffinose, stachyose and verbascose.

The carbohydrate may be present in an amount ranging from 0.01 mM to 150 mM.

Textured proteins are typically processed from an edible protein source with or without suitable ingredients that may be added for nutritional or technological purposes. The textured protein may be provided in a form of fibers, shreds, chunks, bits, granules, slices, gels or other forms. To prepare products for consumption, the textured fibrous protein may be hydrated and the fibers are extracted.

In some embodiments, the textured protein is made by extrusion, resulting in a modified protein structure of a fibrous, spongy matrix material. In some embodiments, the textured protein may be dehydrated or non-dehydrated.

Irrespective of the method of texturization, a textured protein is an extract material which may be derived from a variety of non-animal sources, including plants and fungi. The material may be derived from plants such as legumes and cereals, including beans, rice, maize, barley, sorghum, millet, oats, rye, triticale, breadnut, buckwheat, chia, cockscomb, quinoa, a variety of oilseeds and others. The textured protein may be a textured vegetable protein (TVP). The TVP may be a textured soy protein (TSP), soy meat, or soya chunks.

In some embodiments, the textured protein is a textured plant or fungi protein being, in some embodiments, a textured soy protein.

The amount of the textured protein, e.g., TVP, is between 10 to 25 wt % of the composition. In some embodiments, the amount of the textured protein is between 10 and 24 wt %, 10 and 23 wt %, 10 and 22 wt %, 10 and 21 wt %, 10 and 20 wt %, 10 and 19 wt %, 10 and 18 wt %, 10 and 17 wt %, 10 and 16 wt %, 10 and 15 wt %, 10 and 14 wt %, 10 and 13 wt %, 10 and 12 wt %, 15 and 25 wt %, 15 and 20 wt %, 15 and 19 wt %, 15 and 18 wt %, 15 and 17 wt %, 17 and 25 wt %, 17 and 20 wt %, or between 20 and 25 wt % of the composition. In some embodiments, the amount of the textured protein is 10, 11, 12, 13, 14, 15, 16, 17, 18, 19, 20, 21, 22, 23, 24 or 25 wt % of the composition.

The non-textured protein may be any egg protein, plant protein or cell cultured chicken protein. The non-textured protein may be a vegetable-protein, such as soybean protein, a protist-proteins such as yeast and other microbial agents, or animal or fish protein, such as casein. In some embodiments, the non-textured protein is cell cultured animal cells. In some embodiments, the textured cells are selected from stem cells, fibroblasts, muscle cells, adipose cells, blood cells, satellite cells and others.

In some embodiments, the non-textured protein is an animal or fish protein, or in a form of cultured chicken cells, e.g., chicken stem cells, fibroblasts, muscle cells, adipose cells, blood cells, satellite cells and others.

In some embodiments, the cultured chicken cell is provided at a density or concentration of at least 10×10⁶ million cells per gram of the product. In some embodiments, the cell density or concentration is between 10×10⁶ and 90×10⁶ million cells per gram of product.

In some embodiments, a biomass/composition or a meat product of the invention comprises at least 5 wt % of the non-textured protein. In some embodiments, the amount of non-textured protein is between 5 and 30 wt %. In some embodiments, the amount of the non-textured protein is between 5 and 25 wt %, 5 and 20 wt %, 5 and 15 wt %, 5 and 10 wt %, 10 and 35 wt %, 15 and 35 wt %, 20 and 35 wt %, 25 and 35 wt %, 30 and 35 wt %, 7 and 25 wt %, 7 and 20 wt %, 7 and 15 wt %, or between 7 and 10 wt %.

The inclusion of non-textured protein in the biomass/composition from which the meat product is manufactured dramatically increases the viscosity and other mechanical properties of the biomass/composition, allowing it to create a hard gel at relatively low temperatures around 65° C.

In some embodiments, the biomass/composition or meat product comprises
at least one non-animal derived arachidonic acid (20:4);
at least one amino acid or an amino acid combination comprising two or more amino acids, such as cysteine and lysine;
at least one carbohydrate such as ribose, or a modified carbohydrate;
a textured protein, being optionally a plant or fungi protein;
a non-textured protein, being selected, for example, from egg protein, plant protein or cultured chicken cells; and
at least one additive.

In some embodiments, the biomass/composition or meat product comprises
at least one non-animal derived arachidonic acid (20:4), optionally in an amount of at least 0.05 ppm or in an amount ranging between 0.05 and 10 ppm;
at least one amino acid or an amino acid combination comprising two or more amino acids, such as cysteine and lysine; the amount of the amino acid ranging between 0.05 and 0.08 wt %; in some embodiments, cysteine may be present in an amount between 0.03 and 0.07 wt % and wherein the amount of lysine is between 0.05 and 0.09 wt %;
at least one carbohydrate such as ribose, or a modified carbohydrate, in an amount between 0.01 and 0.1 wt %;
a textured protein, being optionally a plant or fungi protein, in an amount between 10 to 25 wt %;
a non-textured protein, being selected, for example, from egg protein, plant protein or cultured chicken cells, in an amount of between 5 and 30 wt %; and
at least one additive.

The additive used in a biomass/composition or meat products of the invention may be a coloring agent, an olfactory agent, a stabilizing agent, an antioxidant, and others. In some embodiments, the additive may be selected from thiamine (vitamin B1), glucose, fructose, ribose, arabinose, glucose-6 phosphate, fructose 6-phosphate, fructose 1,6-diphosphate, inositol, maltose, sucrose, maltodextrin, glycogen, nucleotide-bound sugars, molasses, a phospholipid, a lecithin, inosine, pyrazine, lactic acid, succinic acid, glycolic acid, thiamine, creatine, pyrophosphate, vegetable oil, algal oil, corn oil, soybean oil, palm fruit oil, palm kernel oil, safflower oil, flaxseed oil, rice bran oil, cottonseed oil, olive oil, sunflower oil, canola oil, flaxseed oil, coconut oil, mango oil, a free fatty acid, cysteine, methionine, isoleucine, leucine, lysine, phenylalanine, threonine, tryptophan, valine, arginine, histidine, alanine, asparagine, aspartate, glutamate, glutamine, glycine, proline, serine, tyrosine, glutathione, a protein hydrolysate, a malt extract, a yeast extract, and others.

In some embodiments, the at least one additive may be alternatively selected from plant fibers (e.g., citrus fibers), and food acids such as citric acid, lactic acid, and ascorbic acid.

In some embodiments, the at least one additive is a flavoring agent or a material which upon heating or cooking or grilling the chicken-like food product, a chicken-like flavor is imparted to the food product.

In some embodiments, the at least one additive is an olfactory agent selected to contribute to the product's aroma.

In some embodiments, the at least one additive is 2-methyl-3-furanthiol. In some embodiments, the amount of 2-methyl-3-furanthiol is between 0.05 to 10 ppm. In some embodiments, the amount of 2-methyl-3-furanthiol is between 0.05 and 9 ppm, 0.05 and 8 ppm, 0.05 and 7 ppm, 0.05 and 6 ppm, 0.05 and 5 ppm, 0.05 and 4 ppm, 0.05 and 3 ppm, 0.05 and 2 ppm, 0.05 and 1 ppm, 0.05 and 0.5 ppm, 0.05 and 0.1 ppm, 0.1 and 10 ppm, 0.1 and 9 ppm, 0.1 and 8 ppm, 0.1 and 7 ppm, 0.1 and 6 ppm, 0.1 and 5 ppm, 0.1 and 4 ppm, 0.1 and 3 ppm, 0.1 and 2 ppm, 0.1 and 1 ppm, 1 and 10 ppm, 2 and 9 ppm, 3 and 8 ppm, 4 and 7 ppm, 5 and 10 ppm, or between 5 and 9 ppm. In some embodiments, the amount is 0.05 ppm, 0.1 ppm, 0.15 ppm, 0.2 ppm, 0.25 ppm, 0.3 ppm, 0.35 ppm, 0.4 ppm, 0.45 ppm, 0.5 ppm, 0.55 ppm, 0.6 ppm, 0.65 ppm, 0.7 ppm, 0.75 ppm, 0.8 ppm, 0.85 ppm, 0.9 ppm, 0.95 ppm, 1 ppm, 2 ppm, 3 ppm, 4 ppm, 5 ppm, 6 ppm, 7 ppm, 8 ppm, 9 ppm, or 10 ppm.

In some embodiments, the biomass/composition or the meat product comprises
at least one non-animal derived arachidonic acid (20:4) and 2-methyl-3-furanthiol in an amount or a ratio as disclosed herein;
at least one amino acid or an amino acid combination comprising two or more amino acids, such as cysteine and lysine;
at least one carbohydrate such as ribose, or a modified carbohydrate;
a textured protein, being optionally a plant or fungi protein;
a non-textured protein, being selected, for example, from egg protein, plant protein or cultured chicken cells; and
optionally at least one additive.

The invention further provides a biomass/composition or a poultry substitute, e.g., chicken substitute product comprising:
a non-animal derived arachidonic acid (20:4), the non-animal source being a plant source or any of the sources detailed herein;
cysteine and lysine;
ribose;
a textured protein, being optionally a plant or fungi protein, e.g., TVP;
a non-textured protein derived from cultured chicken cells; and
2-methyl-3-furanthiol.

In some embodiments, the non-animal derived arachidonic acid (20:4) is in a form of a mushroom oil, optionally providing an effective amount of arachidonic acid that is at least 0.05 ppm or an amount ranging between 0.05 and 10 ppm.

In some embodiments, the amount of the cysteine, lysine and ribose, combined is between 0.1 and 0.3 wt %. In some embodiments, the ratio between a combined amount of cysteine and lysine to an amount of ribose is 1:3. In some embodiments, the amount of ribose is smaller than the combined amount of the cysteine and lysine. In some embodiments, the ratio amount of amino acid(s) to ribose is 1:1, 1:2, 1:3, 2:1, 3:1.

In some embodiments, the biomass/composition or meat product comprises a Maillard reaction strengthener selected from amino acids, non-reducing sugars, phospholipid, lecithin, inosine, inosine monophosphate (IMP), guanosine monophosphate (GMP), pyrazine, adenosine monophosphate (AMP), thiamine, creatine, pyrophosphate, wherein the amino acids are as defined herein. The non-reducing sugars, as detailed herein.

In some embodiments, the biomass/composition or product comprises at least one plant oil. The plant oil may be any edible oil derived from plant materials. The oils are typically liquids at ambient temperature; however, depending on their composition may be provided as solids at room temperature. The edible plant oil may be selected from flaxseed oil, almond oil, argan oil, avocado oil, canola oil, coconut oil, corn oil, cottonseed oil, grapeseed oil, hazelnut oil, hemp seed oil, macadamia nut oil, oat bran oil, olive oil, palm oil, peanut oil, pistachio oil, rapeseed oil, rice bran oil, soybean oil, sesame oil, sunflower seed oil, walnut oil and mixtures thereof.

In some embodiments, the oil is provided in an amount between 4 and 15 wt %.

In some embodiments, the oil is rapeseed oil or flaxseed oil.

In some embodiments, the plant oil is an omega-3 rich oil.

In some embodiments, the plant oil is a mixture of oil comprising flaxseed oil, e.g., in an amount between 0.1 and 15 wt %.

In some embodiments, the biomass/composition or meat product comprises at least one gelling agent. The gelling agent may be any edible material that is capable of increasing viscosity of a fluid or a flowing composition by forming a gel. Typically, gelling agents may include polysaccharide gelling agents, polypeptide gelling agents as well as various polymers such as carrageenan, xanthan gum, guar gum, acacia gum, locust bean gum, tara gum, tamarind gum, karaya gum, cassia gum, konjac, tracaganth, gellan, gelatin, curdlan, alginic acid, alginate, pectin, carboxymethylcellulose, methylcellulose, hydroxypropyl cellulose, hydroxypropyl methyl cellulose, ethyl cellulose, ethyl methyl cellulose, cyclodextrin, polydextrose, polyvinylpyrrolidone, polyvinyl alcohol, and polyethylene glycol.

In some embodiments, the gelling agent is methylcellulose.

In some embodiments, the amount of the gelling agent is between 0.1 and 5 wt %.

In some embodiments, the meat product, e.g., poultry-like meat product comprises a combination of at least one textured protein and at least one non-textured protein.

In some embodiments, the poultry-like product comprises:
a) 0.05 ppm or more non-animal derived arachidonic acid (20:4)
b) 5 mM of more of cysteine, lysine, and ribose
c) Textured plant or fungi protein
d) 5% or more by weight of non-textured protein selected from egg protein, plant protein and cultured chicken cells,
wherein the product contains fibers aligned in multiple or different or random directions and wherein cooking of the poultry-like meat product results in production of at least two volatile compounds having a chicken-associated aroma.

In some embodiments, the arachidonic acid is present in an amount between 0.05 to 10 ppm, or 0.1 ppm.

In some embodiments, the arachidonic acid is derived from mushroom oil.

In some embodiments, the meat product comprises between 0.05 to 10 ppm of 2-methyl-3-furanthiol, or 0.1 ppm of 2-methyl-3-furanthiol.

In some embodiments, the textured protein is soy protein, present in an amount between 10 to 25% by weight, or 17% or 20% by weight.

In some embodiments, the non-textured protein is cell cultured chicken cells selected from stem cells, fibroblasts, muscle cells, adipose cells, blood cells, satellite cells and others.

In some embodiments, cell cultured chicken cell density in a final product is over 10×10⁶ million cells per gram final product, or 60×10⁶ million cells per gram.

The invention further provides a method of manufacturing a poultry-like food product, the method comprising obtaining a biomass or material composition as defined herein and forming the poultry-like food product under conditions permitting isotropic distribution of protein fibers, e.g., textured protein fibers, contained in said biomass.

Typically, methods of the invention are carried out under low temperature conditions not exceeding 99 or 100° C. Typically also, methods of the invention involve extrusion of a biomass or an emulsion of components under such low temperature conditions. The term “extrusion” as used herein, refers to a step of pushing the material composition, a biomass or an emulsion formed therefrom through a shaping tool, e.g., an extrusion nozzle, operated or maintained at a temperature below 99° C., or not exceeding 99° C., hence “low temperature extrusion”. The low temperature extrusion avoids formation of Maillard reaction derived products in the raw food product or uncooked or pre-grilled food product, yet allows for isotropic distribution of the protein fibers in the product.

In some cases, the conditions employed in methods of the invention include thermally treating the material composition, biomass or emulsion made therefrom at a temperature below 99° C. for a period of several minutes, and under increased pressures, without needing to resort or use extrusion systems.

In some embodiments, the biomass or material composition comprises a flavoring amount of 2-methyl-3-furanthiol and a non-animal derived arachidonic acid (20:4) for imparting a poultry, e.g., chicken, flavor to the food product.

The flavoring amount is an amount of one or both of 2-methyl-3-furanthiol and a non-animal derived arachidonic acid (20:4) that is greater than that giving a perceptible flavor of chicken meat, but less than that amount which adversely affects the flavor of the product.

In some embodiments, the amount of each or both of 2-methyl-3-furanthiol and a non-animal derived arachidonic acid (20:4) is a synergistic amount, as defined herein.

In some cases, the amount of each or both of 2-methyl-3-furanthiol and a non-animal derived arachidonic acid (20:4) is between 0.05 to 10 ppm. In some embodiments, the amount of 2-methyl-3-furanthiol and/or the non-animal derived arachidonic acid (20:4) is between 0.05 and 9 ppm, 0.05 and 8 ppm, 0.05 and 7 ppm, 0.05 and 6 ppm, 0.05 and 5 ppm, 0.05 and 4 ppm, 0.05 and 3 ppm, 0.05 and 2 ppm, 0.05 and 1 ppm, 0.05 and 0.5 ppm, 0.05 and 0.1 ppm, 0.1 and 10 ppm, 0.1 and 9 ppm, 0.1 and 8 ppm, 0.1 and 7 ppm, 0.1 and 6 ppm, 0.1 and 5 ppm, 0.1 and 4 ppm, 0.1 and 3 ppm, 0.1 and 2 ppm, 0.1 and 1 ppm, 1 and 10 ppm, 2 and 9 ppm, 3 and 8 ppm, 4 and 7 ppm, 5 and 10 ppm, or between 5 and 9 ppm. In some embodiments, the amount is 0.05 ppm, 0.1 ppm, 0.15 ppm, 0.2 ppm, 0.25 ppm, 0.3 ppm, 0.35 ppm, 0.4 ppm, 0.45 ppm, 0.5 ppm, 0.55 ppm, 0.6 ppm, 0.65 ppm, 0.7 ppm, 0.75 ppm, 0.8 ppm, 0.85 ppm, 0.9 ppm, 0.95 ppm, 1 ppm, 2 ppm, 3 ppm, 4 ppm, 5 ppm, 6 ppm, 7 ppm, 8 ppm, 9 ppm, or 10 ppm.

In some embodiments, the method comprises forming a biomass or material composition comprising arachidonic acid (20:4) and a hydrated textured plant or fungi protein. In some embodiments, the method comprises adding arachidonic acid (20:4) to a hydrated textured plant or fungi protein.

In some embodiments, the method comprises hydrating a textured plant or fungi protein, as defined herein. The hydration may be achievable by treating the protein with a predefined amount of water or a water-containing solution.

In some embodiments, the combined hydrated protein and arachidonic acid (20:4) is treated with at least one Maillard reaction strengthener.

In some embodiments, the method comprises combining the hydrated textured protein, arachidonic acid (20:4) and Maillard reaction strengthener with a mixture comprising at least one plant oil, at least one gelling agent and a non-textured protein to obtain an emulsion or an oleogel.

In some embodiments, the method comprises forming a mixture of at least one plant oil, at least one gelling agent and a non-textured protein.

In some embodiments, the emulsion/oleogel is treated under processing conditions to produce the chicken-like product. In some embodiments, the processing conditions comprise thermally treating the emulsion at a temperature below 99° C. for a period of several minutes, and under increased pressure, e.g., a pressure above atmospheric pressure, or a pressure of 2, 3, 4, or 5 bars. In some embodiments, the thermal treatment proceeds for a period between 1 and 20 minutes or 1 and 10 minutes.

In some embodiments, the method comprises:
hydrating a textured plant or fungi protein with water;
treating the hydrated protein with a plant or mushroom oil rich in arachidonic acid (20:4), 2-methyl-3-furanthiol and with a Maillard reaction strengthener;
mixing in a plant oil with a gelling agent and a non-textured protein to form an emulsion or an oleogel; and
heating the emulsion at a temperature below 99° C., for less than 10 minutes, under a pressure of 5 bar or lower; wherein the heating does not essentially induce formation of Maillard reaction products.

In other words, the method may be utilized for producing a raw (or an uncooked) poultry-like food product being substantially free of Maillard-based products (namely being free of products formed by a Maillard reaction induced by cooking or grilling of the raw food product at temperatures above 100° C.), which may be subsequently cooked or grilled to induce generation of two or more volatile Maillard products which have a poultry, or chicken-associated aroma.

In some embodiments, the method comprises
heating the emulsion/oleogel to obtain a gelled product.

In some embodiments, the method comprises
extruding the gelled product, e.g., through an extrusion nozzle, to produce the raw poultry, e.g., chicken-like product, wherein the raw product contains fibers aligned in multiple directions creating an isotropic bite, and wherein the raw product is composed or configured when cooked or grilled to release at least two volatile compounds imparting a poultry, or chicken-associated aroma.

In some embodiments, the method comprises:
hydrating a textured plant or fungi protein with water;
treating the hydrated protein with a plant or mushroom oil rich in arachidonic acid (20:4), 2-methyl-3-furanthiol and with a Maillard reaction strengthener;
mixing in a plant oil with a gelling agent and a non-textured protein to form an emulsion or an oleogel;
heating the emulsion at a temperature below 99° C., for less than 10 minutes, at a pressure under 5 bar to form a gelled product; and
extruding the gelled product, e.g., through an extrusion nozzle, to produce a raw poultry, e.g., chicken-like product, wherein the raw product contains isotropically aligned textured protein fibers, wherein cooking or grilling of the raw product causes evolution of at least two volatile compounds endowing said cooked or grilled product with a poultry, or chicken-associated aroma.

The invention further provides a method for forming a poultry-like food product, the method comprising
combining a textured plant or fungi protein, arachidonic acid (20:4), 2-methyl-3-furanthiol, a Maillard reaction strengthener and an gelled product formed of a plant oil with a gelling agent and a non-textured protein; and
extruding the gelled product to produce a raw poultry, e.g., chicken-like product, wherein the product contains fibers aligned in multiple directions.

The invention further provides a method for manufacturing a poultry-like food product, the method comprising:
hydrating a textured plant or fungi protein with water;
treating the hydrated protein with a plant or mushroom oil rich in arachidonic acid (20:4), 2-methyl-3-furanthiol and with a Maillard reaction strengthener;
mixing in a plant oil with a gelling agent and a non-textured protein to form an emulsion;
heating the emulsion at a temperature below 99° C., for less than 10 minutes, at a pressure under 5 bar to form a gelled product; and
extruding the gelled product, e.g., through an extrusion nozzle, to produce a raw poultry, e.g., chicken-like product, wherein the raw product contains fibers aligned in multiple directions creating an isotropic bite, wherein cooking or grilling of the raw product causes evolution of at least two volatile compounds endowing said cooked or grilled product with a poultry, or chicken-associated aroma.

Cooking or grilling of the raw poultry-like food product may be achievable at any temperature above 100° C. In some embodiments, the temperature may be above 110, 120, 130 or 140° C.

The at least two volatile compounds are Maillard-reaction products that give the final product a poultry-associated aroma. Without wishing to be bound by theory, these compounds may be reaction products derived from an interaction of the reducing sugars with the amino acids. These compounds may include dicarbonyls for flavor, and melanoidin for color. Alternatively or additionally, the compounds may be products of lipid oxidations, resulting in products such as 3,5-dimethyl-1,2,4-trithiolanes, 2,4,6-trimethylperhydro-1,3,5-dithiazines, 3,5-diisobutyl-1,2,4-trithiolane, 3-methyl-5-butyl-1,2,4-trithiolane, 3-methyl-5-pentyl-1,2,4-trithiolane, 2,4-decadienal, trans-4,5-epoxy-trans-2-decenal, and alkylpyrazines.

In some embodiments, the extrusion nozzle is a high-pressure nozzle.

In some embodiments, the high-pressure nozzle is provided at an outlet of a heater configured to thermally treat the gelled product at temperatures below 99 or 100° C., to twist the dough to form uneven surfaces that provide a chicken-like texture after cooking.

In some embodiments, the gelled product comprises randomly aligned TVP structured protein fibers with a protein-containing oleogel, as defined herein.

In some embodiments, in methods of the invention, the textured protein, e.g., TVP, is provided as a mixture with a protein-containing oleogel. Thus, in some implementations of methods and products of the invention, steps of causing gelation of textured plant protein (TVP) with a protein-containing oleogel are included. Such gelation steps may be carried out under temperatures ranging typically between 80 to 99° C.

In some additional aspects of the invention, there are provided the following aspects and embodiments of the invention:

A material composition comprising non-animal derived arachidonic acid (ARA) and a Maillard reaction intensifier comprising at least one isolated amino acids and at least one reducing sugar.

In some embodiments of compositions of the invention, further comprising 2-methyl-3-furanthiol.

In some embodiments of compositions of the invention, the ARA is obtained from lower plant species selected from fungi or mushrooms, liverworts, mosses, hornworts, lycophytes, monilophytes, seagrasses and higher terrestrial plants.

In some embodiments of compositions of the invention, the ARA is derived from a fungi or mushroom source.

In some embodiments of compositions of the invention, the ARA is provided as a mushroom oil.

In some embodiments of compositions of the invention, the ARA is in a form of an oil derived from a fungus.

In some embodiments of compositions of the invention, the fungus is Mortierella alpina I49-N18.

In some embodiments of compositions of the invention, the composition comprises an oil comprising ARA, protein fibers and a Maillard reaction intensifier selected from isolated amino acids and reducing sugars.

In some embodiments of compositions of the invention, comprising at least one textured plant or fungi protein and at least one non-textured protein.

In some embodiments of compositions of the invention, comprising one or more functional additives.

In some embodiments of compositions of the invention, comprising a 1:10 wt ratio of arachidonic acid to 2-methyl-3-furanthiol.

In some embodiments of compositions of the invention, the at least one isolated amino acid is selected from cysteine, cysteine, histidine, isoleucine, leucine, lysine, methionine, phenylalanine, threonine, tryptophan, and valine.

In some embodiments of compositions of the invention, the at least one isolated amino acid is selected from histidine, isoleucine, leucine, lysine, methionine, phenylalanine, threonine, tryptophan, and valine.

In some embodiments of compositions of the invention, the at least one amino acid is selected from alanine, arginine, asparagine, aspartic acid, cysteine, glutamic acid, glutamine, glycine, proline, serine, and tyrosine.

In some embodiments of compositions of the invention, the at least one amino acid is selected from arginine, cysteine, glutamine, tyrosine, glycine, ornithine, proline, and serine.

In some embodiments of compositions of the invention, comprising two or more isolated amino acids or a blend or a combination of isolated amino acids.

In some embodiments of compositions of the invention, the at least one isolated amino acid or a combination of isolated amino acids comprises one or both of cysteine and lysine.

In some embodiments of compositions of the invention, the at least one isolated amino acid is used in combination with at least one carbohydrate at a weight ratio of 1:3 amino acid:carbohydrate.

In some embodiments of compositions of the invention, the carbohydrate is selected from trehalose, galactose, rhamnose, sucrose, glucose, ribulose, fructose, threose, arabinose, xylose, lyxose, allose, altrose, mannose, idose, lactose, maltose, isotrehalose, neotrehalose, isomaltulose, erythrose, deoxyribose, gulose, idose, talose, erythrulose, xylulose, psicose, turanose, amylopectin, glucosamine, mannosamine, fucose, glucuronic acid, abequose, galactosamine, isomaltose, isomaltotriose, panose xylotriose, xylobiose, sorbose, maltotetraol, maltotriol, starch, inulin, raffinose, and ribose.

In some embodiments of compositions of the invention, the carbohydrate is ribose.

In some embodiments of compositions of the invention, the carbohydrate is selected amongst reducing sugars.

In some embodiments of compositions of the invention, the at least one reducing sugar is selected from glucose (dextrose), fructose (levulose), galactose, xylose and ribose.

In some embodiments of compositions of the invention, the Maillard reaction intensifier is selected from glucose, fructose, ribose, arabinose, glucose-6-phosphate, fructose-6-phosphate, fructose-1,6-diphosphate, inositol, maltose, sucrose, maltodextrin, glycogen, nucleotide bound sugars, molasses, honey, corn syrup, maple and agave syrup.

In some embodiments of compositions of the invention, the textured protein is a dehydrated or non-dehydrated protein material.

In some embodiments of compositions of the invention, the textured protein is an extract material derived from a non-animal source.

In some embodiments of compositions of the invention, the extract material is derived from legumes and cereals.

In some embodiments of compositions of the invention, the extract material is derived from beans, rice, maize, barley, sorghum, millet, oats, rye, triticale, breadnut, buckwheat, chia, cockscomb, quinoa, or oilseeds.

In some embodiments of compositions of the invention, the textured protein is a textured vegetable protein (TVP).

In some embodiments of compositions of the invention, the TVP is a textured soy protein (TSP), soy meat, or soya chunks.

In some embodiments of compositions of the invention, the textured protein is a textured plant or fungi protein.

In some embodiments of compositions of the invention, the non-textured protein is an egg protein, plant protein or cultured chicken or other avian cells.

In some embodiments of compositions of the invention, the non-textured protein is a vegetable-protein.

In some embodiments of compositions of the invention, the non-textured protein is cultured animal cells.

In some embodiments of compositions of the invention, the cells are selected from stem cells, fibroblasts, muscle cells, adipose cells, blood cells, and satellite cells.

In some embodiments of compositions of the invention, the non-textured protein is an animal protein in a form of cultured chicken cells.

In some embodiments of compositions of the invention, the cultured chicken cell is provided at a density of at least 10×10⁶ million cells per gram of the product.

In some embodiments of compositions of the invention, comprising:
a non-animal derived arachidonic acid;
at least one isolated amino acid or a combination comprising two or more isolated amino acids;
at reducing sugar;
a textured protein, being optionally a plant or fungi protein;
a non-textured protein selected from egg protein, plant protein and cultured chicken cells; and
at least one additive.

In some embodiments of compositions of the invention, comprising:
a non-animal derived arachidonic acid, in an amount of at least 0.05 ppm or in an amount ranging between 0.05 and 10 ppm;
at least one isolated amino acid or a combination of two or more isolated amino acids; wherein the amount of the isolated amino acid or combination ranging between 0.01 and 0.09 wt %;
at least one reducing agent in an amount between 0.01 and 0.1 wt %;
a textured protein, being a plant or fungi protein, in an amount between 10 to 25 wt %;
a non-textured protein selected from egg protein, plant protein and cultured chicken cells, in an amount of between 5 and 30 wt %; and
at least one additive.

In some embodiments of compositions of the invention, the at least one additive is selected from a coloring agent, an olfactory agent, a stabilizing agent, and an antioxidant.

In some embodiments of compositions of the invention, the at least one additive is selected from thiamine (vitamin B1), glucose, fructose, ribose, arabinose, glucose-6 phosphate, fructose 6-phosphate, fructose 1,6-diphosphate, inositol, maltose, sucrose, maltodextrin, glycogen, nucleotide-bound sugars, molasses, a phospholipid, a lecithin, inosine, pyrazine, lactic acid, succinic acid, glycolic acid, thiamine, creatine, pyrophosphate, vegetable oil, algal oil, corn oil, soybean oil, palm fruit oil, palm kernel oil, safflower oil, flaxseed oil, rice bran oil, cottonseed oil, olive oil, sunflower oil, canola oil, flaxseed oil, coconut oil, mango oil, a free fatty acid, cysteine, methionine, isoleucine, leucine, lysine, phenylalanine, threonine, tryptophan, valine, arginine, histidine, alanine, asparagine, aspartate, glutamate, glutamine, glycine, proline, serine, tyrosine, glutathione, a protein hydrolysate, a malt extract, and a yeast extract.

In some embodiments of compositions of the invention, the at least one additive is plant fibers or food acids.

In some embodiments of compositions of the invention, the at least one additive is a flavoring agent or a material which upon heating or cooking or grilling the food product, imparts a chicken-like flavor.

In some embodiments of compositions of the invention, the at least one additive is an olfactory agent.

In some embodiments of compositions of the invention, comprising 2-methyl-3-furanthiol.

In some embodiments of compositions of the invention, comprising:
a non-animal derived arachidonic acid;
cysteine and lysine;
ribose;
a textured protein, being optionally a plant or fungi protein;
a non-textured protein derived from cultured chicken cells; and
optionally 2-methyl-3-furanthiol.

A material composition for use in forming a chicken-like meat product, the material composition comprising:
a non-animal derived arachidonic acid;
cysteine and lysine;
ribose;
a textured protein, being optionally a plant or fungi protein;
a non-textured protein derived from cultured chicken cells; and
optionally 2-methyl-3-furanthiol.

In some embodiments of compositions of the invention, the composition is for use in a method of manufacturing a poultry-like meat substitute.

In some embodiments of compositions of the invention, the method used for making the composition is carried out at a temperature below 99° C.

A poultry-like meat product comprising a composition according to any one of the compositions disclosed herein.

In some embodiments of products of the invention, the product is a chicken substitute product.

In some embodiments of products of the invention, the products comprising isotropically distributed protein fibers.

In some embodiments of products of the invention, the product comprising
a) 0.05 ppm or more non-animal derived arachidonic acid;
b) 5 mM or more cysteine, lysine, and ribose, combined;
c) textured plant or fungi protein;
d) 5% or more by weight of non-textured protein selected from egg protein, plant protein and cell cultured chicken protein.

In some embodiments of products of the invention, the arachidonic acid is present in an amount between 0.05 to 10 ppm, or 0.1 ppm.

In some embodiments of products of the invention, the arachidonic acid is derived from mushroom oil.

In some embodiments of products of the invention, comprising between 0.05 to 10 ppm of 2-methyl-3-furanthiol, or 0.1 ppm of 2-methyl-3-furanthiol.

In some embodiments of products of the invention, the textured protein is soy protein, present in an amount between 10 to 25% by weight, or 17% or 20% by weight.

In some embodiments of products of the invention, the non-textured protein is cell cultured chicken cells selected from stem cells, fibroblasts, muscle cells, adipose cells, blood cells, and satellite cells.

In some embodiments of products of the invention is a raw product substantially free of Maillard-based products derived from a Maillard reaction.

In some embodiments of products of the invention, the Maillard-based products are selected amongst dicarbonyls, melanoidins, 3,5-dimethyl-1,2,4-trithiolanes, 2,4,6-trimethylperhydro-1,3,5-dithiazines, 3,5-diisobutyl-1,2,4-trithiolane, 3-methyl-5-butyl-1,2,4-trithiolane, 3-methyl-5-pentyl-1,2,4-trithiolane, 2,4-decadienal, trans-4,5-epoxy-trans-2-decenal, and alkylpyrazines.

In some embodiments of products of the invention, is a raw food product formed by a process carried out at a temperature below 99° C.

A method of manufacturing a poultry-like food product, the method comprising obtaining a material composition according to any one of compositions of the invention and forming the poultry-like food product under conditions permitting isotropic distribution of protein fibers contained in said material composition.

In some embodiments of methods of the invention, the material comprises a flavoring amount of 2-methyl-3-furanthiol and a non-animal derived arachidonic acid for imparting a poultry flavor to the food product.

In some embodiments of methods of the invention, the method comprises forming a material composition comprising arachidonic acid and a hydrated textured plant or fungi protein.

In some embodiments of methods of the invention, the combined hydrated textured protein and arachidonic acid is treated with at least one Maillard reaction strengthener.

In some embodiments of methods of the invention, the conditions permitting isotropic distribution of protein fibers comprise thermally treating the material composition at a temperature below 99 DC under increased pressure.

In some embodiments of methods of the invention, the method comprising:
treating the hydrated protein with a plant or mushroom oil rich in arachidonic acid, 2-methyl-3-furanthiol and with a Maillard reaction strengthener;
mixing in a plant oil with a gelling agent and a non-textured protein to form an emulsion or an oleogel; and
heating the emulsion at a temperature below 99° C., for less than 10 minutes, under a pressure of 5 bar or lower; wherein the heating does not essentially induce formation of Maillard reaction products.

In some embodiments of methods of the invention, the method comprising
heating the emulsion/oleogel to obtain a gelled product and extruding the gelled product to produce a raw poultry-like product, wherein the raw product contains fibers aligned in multiple directions creating an isotropic bite.

In some embodiments of methods of the invention, the raw product is composed or configured when cooked or grilled to release at least two volatile compounds imparting a poultry-associated aroma.

In some embodiments of methods of the invention, the method comprises:
hydrating a textured plant or fungi protein with water;
treating the hydrated protein with a plant or mushroom oil rich in arachidonic acid, 2-methyl-3-furanthiol and with a Maillard reaction strengthener;
mixing in a plant oil with a gelling agent and a non-textured protein to form an emulsion or an oleogel;
heating the emulsion at a temperature below 99° C., for less than 10 minutes, at a pressure under 5 bar to form a gelled product; and
extruding the gelled product to produce a raw poultry-like product, wherein the raw product contains isotropically aligned textured protein fibers.

A method for forming a poultry-like food product, the method comprising
combining a textured plant or fungi protein, arachidonic acid, 2-methyl-3-furanthiol, a Maillard reaction strengthener and a gelled product formed of a plant oil with a gelling agent and a non-textured protein; and
extruding the gelled product to produce a raw poultry-like product, wherein the product contains fibers aligned in multiple directions.

A method for manufacturing a poultry-like food product, the method comprising:
hydrating a textured plant or fungi protein with water;
treating the hydrated protein with a plant or mushroom oil rich in arachidonic acid, 2-methyl-3-furanthiol and with a Maillard reaction strengthener;
mixing in a plant oil with a gelling agent and a non-textured protein to form an emulsion;
heating the emulsion at a temperature below 99° C., for less than 10 minutes, at a pressure under 5 bar to form a gelled product; and
extruding the gelled product to produce a raw poultry-like product, wherein the raw product contains fibers aligned in multiple directions creating an isotropic bite, wherein cooking or grilling of the raw product causes evolution of at least two volatile compounds endowing said cooked or grilled product with a poultry, or chicken-associated aroma.

In some embodiments of methods of the invention, the method comprises cooking or grilling the raw poultry-like food product at a temperature above 100° C.

In some embodiments of methods of the invention, the extruding comprises extrusion through a high-pressure nozzle.

A chicken-like meat product formed by low temperature extrusion of a composition comprising:
a non-animal derived arachidonic acid;
at least one isolated amino acid or a combination comprising two or more isolated amino acids;
at reducing sugar;
a textured protein, being optionally a plant or fungi protein;
a non-textured protein selected from egg protein, plant protein and cultured chicken cells; and
at least one additive.

A grilled or cooked chicken-like meat product formed by grilling or cooking an extrudate (a product of the extrusion process or step) comprising:
a non-animal derived arachidonic acid;
at least one isolated amino acid or a combination comprising two or more isolated amino acids;
at reducing sugar;
a textured protein, being optionally a plant or fungi protein;
a non-textured protein selected from egg protein, plant protein and cultured chicken cells; and
at least one additive.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-B schematically depict some of the differences between processes and products of the art (FIG. 1A) and processes and products of some embodiments of the present invention (FIG. 1B).

FIGS. 2A-H depict some of the tasting and properties of products of the invention. Side-by-side comparison of cultured and farmed chicken is shown in FIGS. 2A and B. Nutritional analysis of both products is demonstrated in FIG. 2C. Cultured chicken had 20% less saturated fat, and 40% less cholesterol than farmed chicken. However, sodium content was higher by 189 mg/100 g due to the high salt content of textured soy protein (FIG. 2C). Preliminary sensory analysis is shown in FIG. 2D-H.

FIG. 3 is a representing diagram of texture measurements.

FIGS. 4A-B Bar graphs depicting mechanical testing results for bite firmness (peak force) and toughness (total work) for multiple products. Farm-raised commercial chicken product (Sysco Strips) serves as positive control. Daring chicken product produced by high moisture extrusion (HME) are 3-fold tougher than commercial chicken. Gardein filet are formed without extrusion showing 2-fold lower mechanical bite. Future Meat Technologies (FMT) chicken produced with low temperature extrusion, with or without egg albumin, show comparable bite to farmed-chicken.

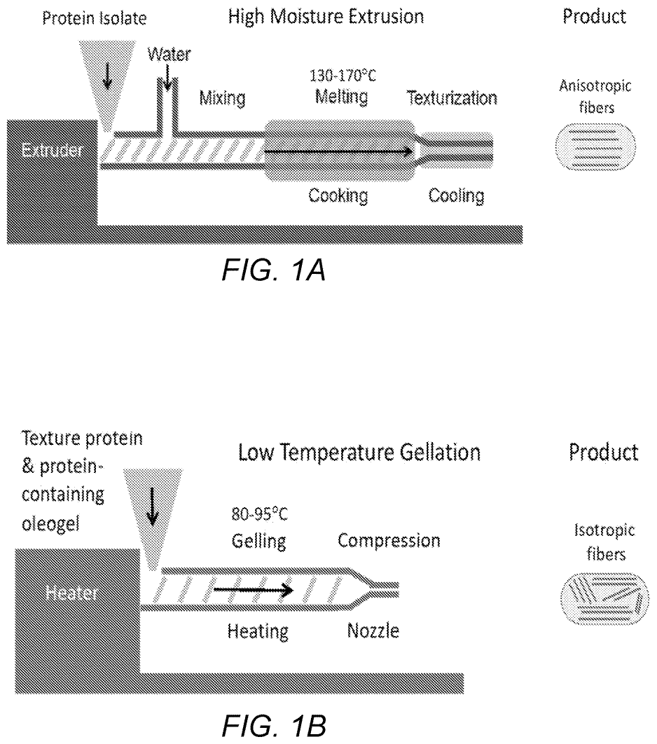

### DETAILED DESCRIPTION OF EMBODIMENTS

The gelation of randomly aligned TVP structured protein with protein-containing oleogel produces randomly aligned fibers which can be sheared into a dominant direction in pressures under 5 bars. Pressures above 5 bar and temperatures above 100° C. leads to fiber realignment, producing an inferior product with aligned and uncoupled fibers. More importantly, temperatures above 100° C. cause the thermal production of Maillard and lipid oxidation products during the manufacturing process, leading to oxidation and off flavors in final product.

Oleogels are oils structured by non-triglyceride networks. They have been a subject of interest in recent years due to their application potential in cosmetics, foods, and pharmaceuticals. To make an oleogel, the methods of the invention may include a step of adding a low concentration of a gelation agent to a plant oil. With an appropriate processing (e.g., including heating, stirring and cooling, for example), the molecules are dispersed in the oil phase and self-assemble to form 3-D networks, structuring the liquid oil. The gelation agent or gelator may be methyl cellulose although others are also functional. The addition of a non-textured protein to oleogels stabilizes the structure resulting in a harder gel. Egg protein, plant protein (e.g., soy protein isolate), as well as animal cell protein can be used interchangeably to form a stable gel.

Gelled chicken analogs produced by heating have smooth surface areas that dry upon cooking. Adding high pressure nozzle at the outlet of the heater convolutes the dough creating uneven surfaces that cook realistically like chicken. To enhance the Maillard reaction on chicken analog a mixture of a reducing sugar, amino acids and thiamine (vitamin B1) were tested in different concentrations. The effect of thiamine was studied at multiple concentration ranging from 0.1 to 20 mM, with optimal concentration identified at 0.4 to 1.3 mM and used in all recipes. The amino acids cysteine and lysine were mixed together and studied against ribose concentrations in a chicken-analog with concentrations ranging from 0.03 to 110 mM (Table 1). Analysis showed that amino acids and ribose at a 1 to 3 ratio was optimal Maillard response on soy analogs.

TABLE 1
Defining concentration of Maillard reaction mix

| # | | AA mix (Rank) | | | |
|---|---|---|---|---|---|
| Experiment | 1-Low | 2 | 3 | 4 | 5-High |

| | | |
|---|---|---|
| Ribose | 1-Low | |
| (Rank) | 2 | |
| | 3 | |
| | 4 | |
| | 5 | |
| | 6 | 1:3 Optimal |
| | 7 | |
| | 8-High | |

To investigate the contribution of various aroma molecules to chicken flavor, stock solutions of the aroma molecules were prepared using oil/water as solvent. Between 0.1 to 10 ppm of each molecule was added to a plant protein matrix. Samples were cooked to an inner temperature of 80° C. Samples were tasted to a working concentration of each molecule was determined. The results of this experiment are shown in Table 2. Arachidonic acid alone showed a fatty off flavor and smell, while 2-methyl-3-furanthiol yielded an aroma similar to cherries.

TABLE 2
Aroma molecules contribution to chicken taste

| Name of molecule | Results |
|---|---|
| E,E-2,4-Decadienal | Savory |
| γ-Dodecalaceton | Nutty, Roasting |
| Furfuryl-Mercaptan | Grilled, Umami, off flavor |
| Arachidonic acid | Fatty, off flavor |
| Trans-2-Undecanal | Raw meat, meaty |
| 2-Methyl-3-Furanthiol | Cherries |

To test whether the materials listed in Table 2 demonstrate a synergetic effect, various combinations of these molecules were formed, in low and high concentrations in chicken analog products and tested.

Table 3 shows that at low concentrations the aroma molecules had a synergetic effect producing a chicken-like aroma not observed with individual molecules.

TABLE 3
Synergetic effect of aroma molecules

| Test | 1 | 2 |
|---|---|---|
| E,E-2,4-Decadienal | High | Low |
| γ-Dodecalaceton | High | Low |
| Furfuryl-Mercaptan | High | Low |
| Arachidonic acid | High | Low |
| Trans-2-Undecanal | High | Low |
| Results | Rancid, Strong | Savory, balanced, |
| | off flavor | Chicken |

To determine which of the 6 combinations was significant contributors to the aroma profile of the chicken-like product, a model was structured using Design of Experiment (DOE) software. This complex optimization algorithm can rapidly deconvolute co-dependencies using a fraction of experimental conditions.

Samples were cooked and a small taste panel tested each sample. Results are shown in Table 4. As shown, arachidonic acid, furfuryl-mercaptan and 2-methyl-3-furanthiol were major contributors to a chicken aroma in plant-based products of the invention.

TABLE 4
Identification of key aroma molecules
contributing to chicken flavor

| | Concentration | | | | | | | | |
|---|---|---|---|---|---|---|---|---|---|
| Component | (ppm) | 1 | 2 | 3 | 4 | 5 | 6 | 7 | 8 |
| E,E-2,4- | 1 | | + | | + | | + | | + |
| Decadienal | | | | | | | | | |
| γ-Dodecalaceton | 0.05 | | | + | + | | | + | + |
| Furfuryl- | 0.05 | | | | | + | + | + | + |
| Mercaptan | | | | | | | | | |
| Arachidonic acid | 0.1 | + | | | + | + | | | + |
| Trans-2- | 0.1 | + | | + | | | + | | + |
| Undecanal | | | | | | | | | |
| 2-Methyl-3- | 1 | + | + | | | | | + | + |
| Furanthiol | | | | | | | | | |

### Tasting and Comparison of Product

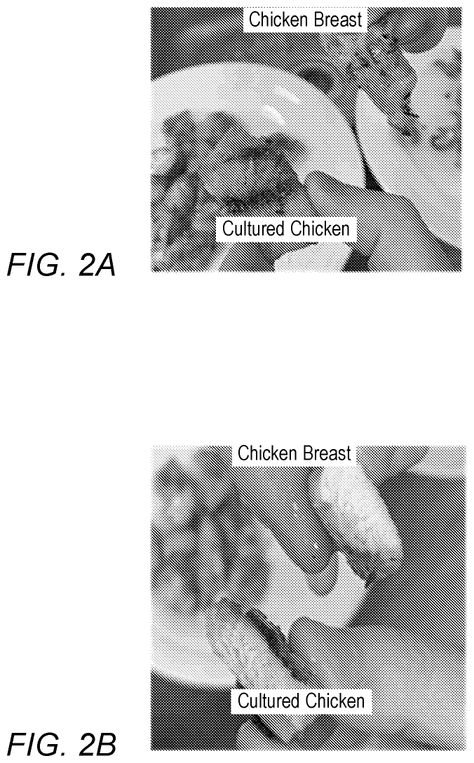

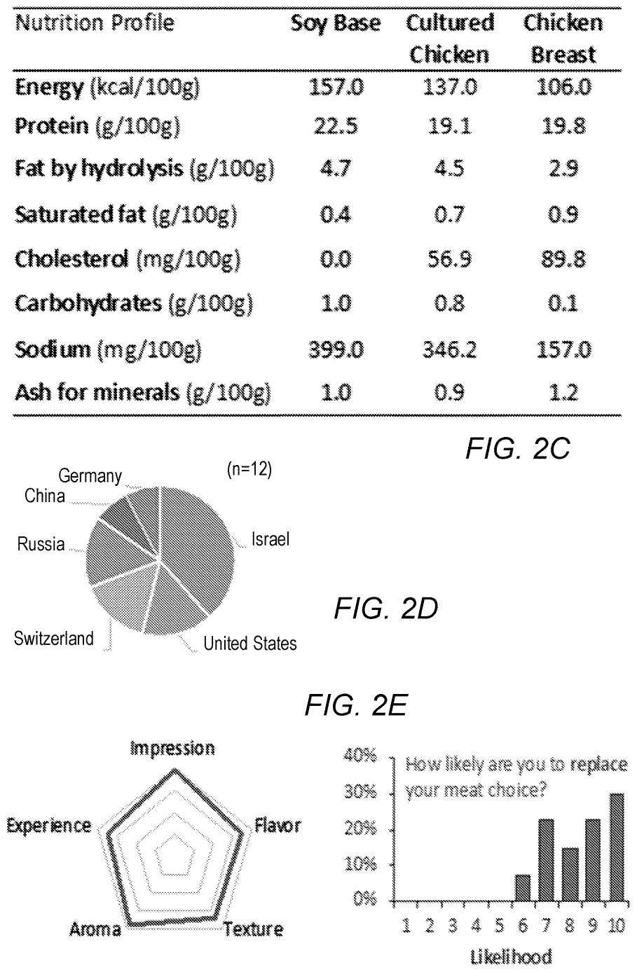

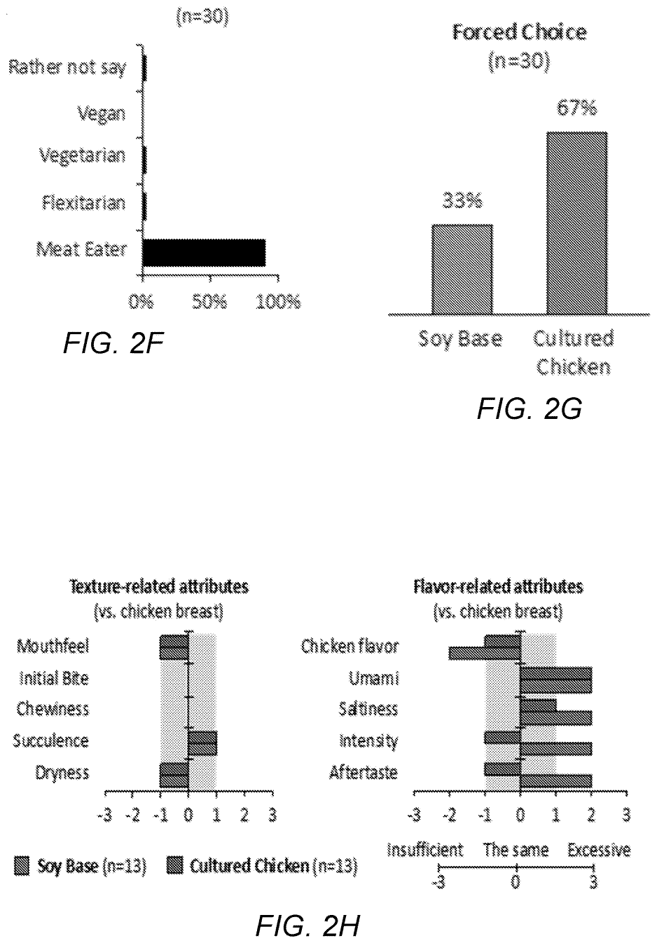

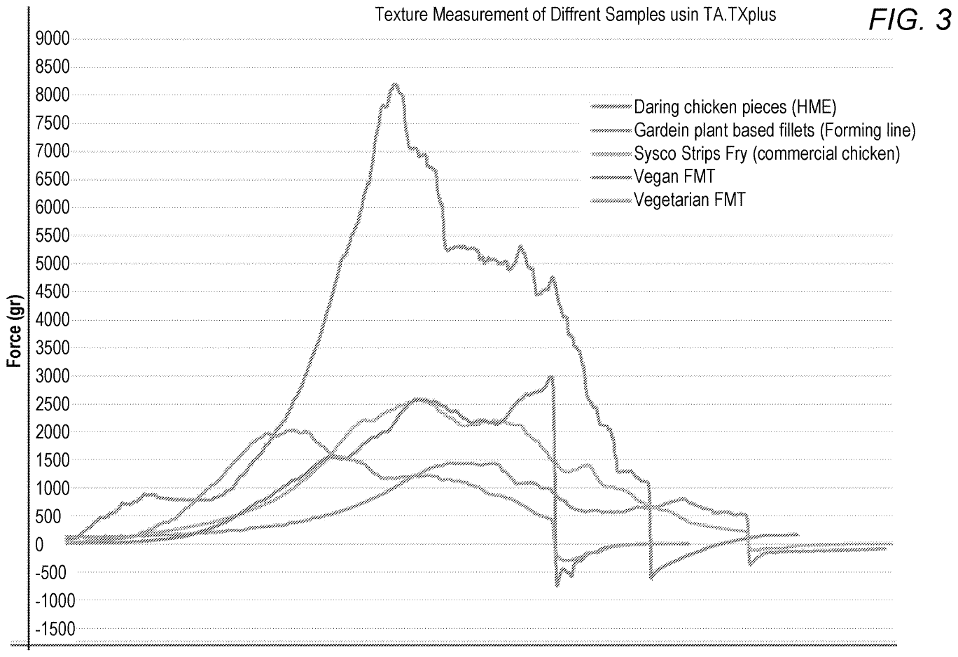

Chicken-like products were produced using extruded plant protein and non-textured protein composed of cell cultured chicken fibroblasts. Side-by-side comparison of cultured and farmed chicken demonstrated similar fiber cross-section and the distinct Maillard caramelization of meat (FIGS. 2A and B). Nutritional analysis of both products suggested similar nutrition values to farmed chicken (FIG. 2C). Cultured chicken had 20% less saturated fat, and 40% less cholesterol than farmed chicken. However, sodium content was higher by 189 mg/100 g due to the high salt content of textured soy protein (FIG. 2C).

TABLE 5
Tasting survey of the exploratory tasting
Please note that this survey can be anonymous.
Participation in this survey is voluntary, and
one may refrain from answering some of the questions.

| Sample number: | | | | | |
|---|---|---|---|---|---|
| Impression | 1 (Very poor) | 2 | 3 | 4 | 5 (Very good) |
| Aroma | 1 | 2 | 3 | 4 | 5 |
| Texture | 1 | 2 | 3 | 4 | 5 |
| Flavor | 1 | 2 | 3 | 4 | 5 |
| Experience | 1 | 2 | 3 | 4 | 5 |

How likely are you to replace meat in your diet with this product?

| | | | | | | | | | |
|---|---|---|---|---|---|---|---|---|---|
| 1 (Unlikely) | 2 | 3 | 4 | 5 | 6 | 7 | 8 | 9 | 10 (Very likely) |

| Sample number: | | | | | |
|---|---|---|---|---|---|
| Impression | 1 (Very poor) | 2 | 3 | 4 | 5 (Very good) |
| Aroma | 1 | 2 | 3 | 4 | 5 |
| Texture | 1 | 2 | 3 | 4 | 5 |
| Flavor | 1 | 2 | 3 | 4 | 5 |
| Experience | 1 | 2 | 3 | 4 | 5 |

How likely are you to replace meat in your diet with this product?

| | | | | | | | | | |
|---|---|---|---|---|---|---|---|---|---|
| 1 (Unlikely) | 2 | 3 | 4 | 5 | 6 | 7 | 8 | 9 | 10 (Very likely) |

| | | | | |
|---|---|---|---|---|
| Name | | | | |
| Age | | | | |
| Contact details | | | | |
| Gender | | | | |
| Nationality | | | | |
| Lifestyle | Vegan | Vegetarian | Flexitarian | Meat eater |

TABLE 6
Tasting survey of the forced choice tasting
You will be offered a taste of two products. Please fill in the sample
number on top of the corresponding column and rate your
impression and experience according to the attributes listed below.
**Please note that while in questions 1-5 and 12 the scale is linear, in
questions 6-11 it is 2-sided, and the middle point is “just right”.

| | Sample | Sample |
|---|---|---|
| | No.__ | No.__ |
| 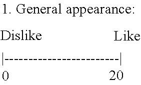 | | |
| 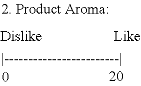 | | |
| 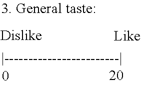 | | |
| 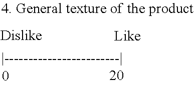 | | |
| 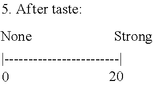 | | |
| 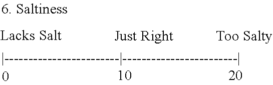 | | |
| 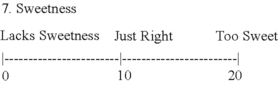 | | |
| 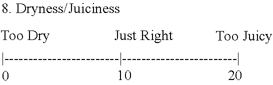 | | |
| 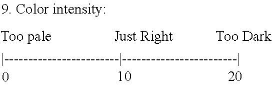 | | |
| 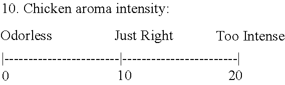 | | |
| 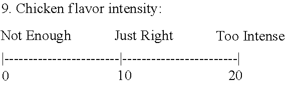 | | |
| 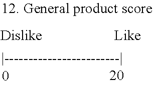 | | |
| Coments: | | |
| 13. Which example do you prefer? | | |
| Please mark it with a (X) | | |
| Please explain the preference: | | |
| Additional comments: | | |
| Age | | |
| Gender | | |
| Nationality | | |

| | | | | |
|---|---|---|---|---|
| Lifestyle | Vegan | Vegetarian | Flexitarian | Meat eater |

TABLE 7
Tasting survey of the blind tasting
You will find in front of you 2 products; a sample defined as your
reference and a test sample. Please first taste the reference sample,
and only then the numbered sample. For each attribute, please score
the numbered sample as compared to the reference.

| | Rating | | | | | | | |
|---|---|---|---|---|---|---|---|---|
| | | Somewhat | Slightly | The | Slightly | Somewhat | | |
| Attribute | Insufficient | Insufficient | Insufficient | Same | Excessive | Excessive | Excessive | N/A |
| Overall | −3 | −2 | −1 | 0 | +1 | +2 | +3 | |
| Saltiness | | | | | | | | |
| Savoriness | −3 | −2 | −1 | 0 | +1 | +2 | +3 | |
| Overall | −3 | −2 | −1 | 0 | +1 | +2 | +3 | |
| Flavor/Taste | | | | | | | | |
| Chicken | −3 | −2 | −1 | 0 | +1 | +2 | +3 | |
| Flavor | | | | | | | | |
| Mouthfeel | −3 | −2 | −1 | 0 | +1 | +2 | +3 | |
| Initial Bite | −3 | −2 | −1 | 0 | +1 | +2 | +3 | |
| Chewiness | −3 | −2 | −1 | 0 | +1 | +2 | +3 | |
| Gumminess | −3 | −2 | −1 | 0 | +1 | +2 | +3 | |
| Seasoning | −3 | −2 | −1 | 0 | +1 | +2 | +3 | |
| Intensity | | | | | | | | |
| Grilled | −3 | −2 | −1 | 0 | +1 | +2 | +3 | |
| Flavor | | | | | | | | |
| Astringency | −3 | −2 | −1 | 0 | +1 | +2 | +3 | |
| Succulence | −3 | −2 | −1 | 0 | +1 | +2 | +3 | |
| Dryness | −3 | −2 | −1 | 0 | +1 | +2 | +3 | |

TABLE 8
Median, quartile 1 (Q1), quartile 3 (Q3) and interquartile
range (IQR) of the blinded reference-based tasting

| | Soy Base | | | | Cultured Chicken | | | |
|---|---|---|---|---|---|---|---|---|
| Attribute | Median | Q1 | Q3 | IQR | Median | Q1 | Q3 | IQR |
| Dryness | −1 | −1 | 0 | 1 | −1 | −1 | 0 | 1 |
| Succulence | 1 | −1 | 0 | 1 | 1 | −1 | 0 | 1 |
| Chewiness | 0 | −1 | 1 | 2 | 0 | −2 | 1 | 3 |
| Initial bite | 0 | −1 | 1 | 2 | 0 | −2 | 1 | 3 |
| Mouthfeel | −1 | −1 | 0 | 1 | −1 | −1 | 0 | 1 |
| Aftertaste | 2 | −1 | 0 | 1 | 1 | 0 | 1 | 1 |
| Intensity | 2 | −1 | 0 | 1 | 2 | 0 | 1 | 1 |
| Saltiness | 2 | 0 | 0 | 0 | 1 | 0 | 1 | 1 |
| Umami | 2 | −1 | 0 | 1 | 2 | −1 | 0 | 1 |
| Chicken flavor | −2 | 0 | 1 | 1 | −1 | 0 | 0 | 0 |

Preliminary sensory analysis was performed in a non-blinded test (Table 5). Participants included multiple ethnic backgrounds with 84% identifying as meat-eaters and 7% as flexitarians (FIG. 2D). Participants were asked to grade the blended chicken product from 0 to 5 on five attributes including overall impression, flavor, texture, aroma, and overall experience, the average score was 4.5 (FIG. 2E). When asked “how likely are you to replace your meat choice with this product?” the average likelihood stated by the participants was 8/10 (FIG. 2E).

Next, two independent blind tastings studies were conducted. In the first study, among 30 participants, 90% identified themselves as meat eaters (FIG. 2F, Table 6). In this blinded, forced choice tasting, participants compared cultured chicken to its soy base, with identical, minimal seasoning. Over 67% of the participants preferred cultured chicken over the textured soy base product (FIG. 2G, Table 7).

Then, a second blinded sensatory tasting analysis was performed, comparing either cultured chicken or its soy base to a reference product (farmed chicken breast). Participants rated the products as compared to the reference on texture-related (mouthfeel, initial bite, chewiness, succulence, dryness) and flavor-related (chicken flavor, umami, saltiness, intensity, aftertaste) attributes (n=13; FIG. 2H, Table 8). The results show that the addition of cultured adipose-like cells to the soy base improved rating of all flavor-related attributes, without significantly affecting the product texture.

### Vegan Base Product Production

An oleogel containing vegetable and fungi oils, soy protein isolate, and water was made by mixing the ingredients in a bowl cutter for 6 minutes. In a separate unit, a textured soy protein (TSP) was hydrated with water while gently mixing to release the fibrous texture of the TSP. Hydration was achieved under vacuum conditions for 15 minutes. Additional soy protein isolate and water were mixed with the hydrated TSP for 6-7 minutes until homogenous.

The oleogel was mixed into the hydrated TSP for 2-5 minutes until homogenous. The resulting mixture was transferred into further processing in a low temperature extruder. The mixture was pumped into the process at an initial temperature of 20° C., flowed through the process for 2-3 minutes, and was heated to a final temperature of 95° C. The extruded product was then passed through cutting equipment to receive a chicken strip-like shape.

The final product was immediately frozen in a blast freezer to a temperature of (−40° C.) and then stored at (−18° C.).

### Vegetarian Base Product Production

An oleogel containing vegetable fungi oils, soy protein isolate, and water was made by mixing these ingredients in a bowl cutter for 6 minutes. In separate equipment, a textured soy protein (TSP) was hydrated with water while gently mixing to release the fibrous texture of the TSP. Hydration was achieved under vacuum conditions for 15 minutes. Additional dried egg albumin, flavorings, and water were mixed with the hydrated TSP for 6-7 minutes until homogenous.

The oleogel was mixed into the hydrated TSP for 2-5 minutes until homogenous. The resulting mixture was transferred into further processing in a low-temperature extruder. The final mix was pumped into the process at an initial temperature of 20° C., flowed through the process for 2-3 minutes, and was heated to a final temperature of 90° C. The cooked mixture was then passed through cutting equipment to receive a chicken strip-like shape.

The final product was frozen in a blast freezer to a temperature of −40° C. and then stored at −18° C.

### Texture Analysis

All samples of products formed as disclosed herein, as well as products known in the art were thawed at 4° C. for 24 hours until fully thawed.

Each sample was heated in a slightly oiled pan until the internal temperature reached 75-80° C. Samples were heated separately and adjacent to measuring to avoid cooling before measuring. The measurement was made using a TA.TX plus analyzer (Stable Micro System) equipped with a 5 kg load cell (For the Daring sample, a 50 kg load cell was used due to the high peak force). A Warner Bratzler Blade Set with a ‘V’ slot blade (Stable Micro System HDP/WBV) was used for all samples.

### Test Parameters:

Pre-test: 2 mm\sec
Test speed: 2 mm\sec
Post-test speed: 10 mm\sec
Target distance: 25 mm
Trigger force 20 g

At least four duplicates were tested from each sample, and the results were analyzed using Exponent Connect software (stable micro systems). For each sample, Firmness was defined as the maximum peak force (gr) and Toughness as the work of shear (gr*sec). Average and SD were calculated for each parameter for each sample.

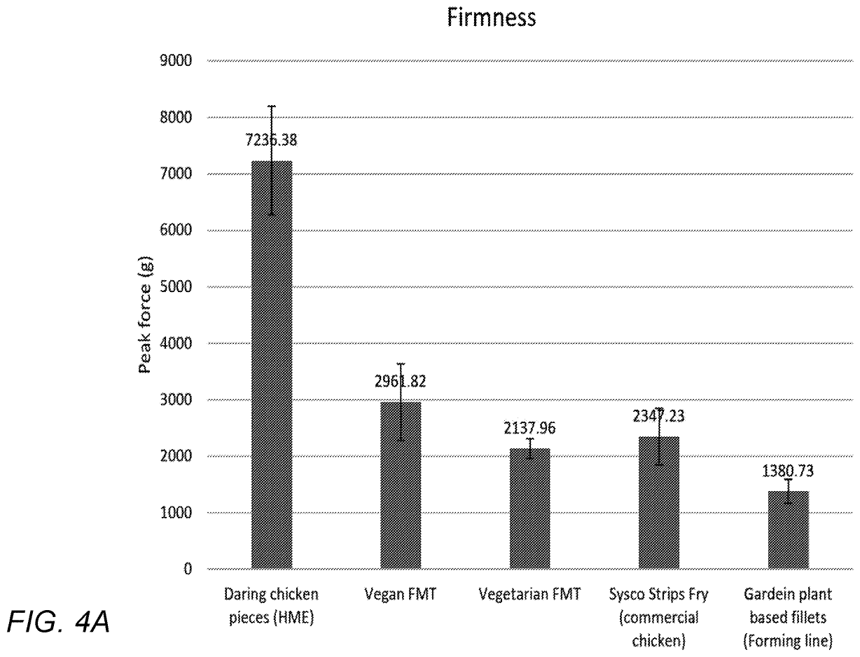

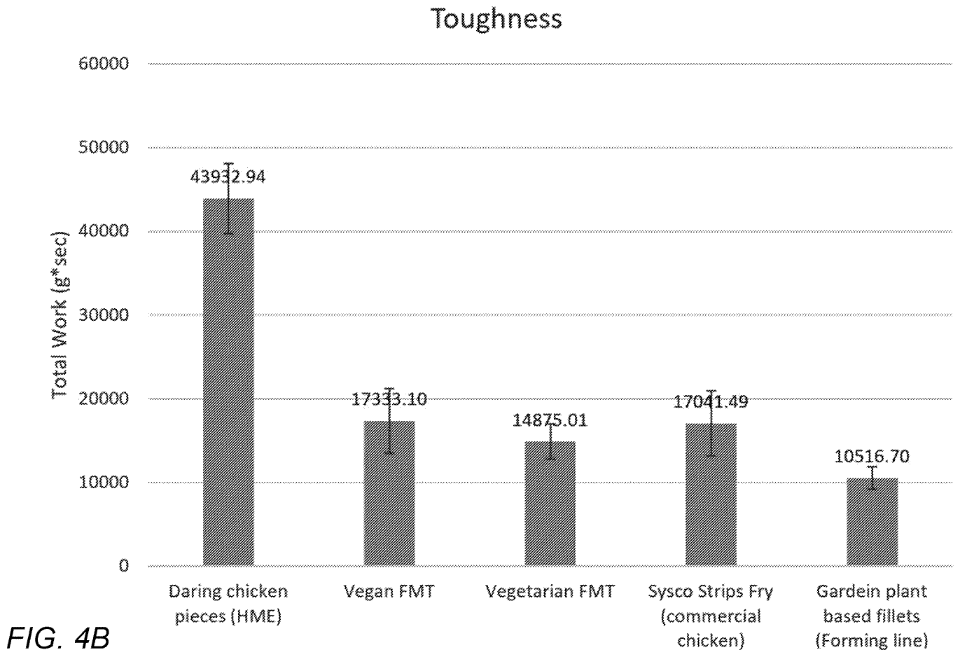

The analysis summarized in FIG. 4A-B depicts mechanical testing results for bite firmness (peak force) and toughness (total work) for multiple products. Farm-raised commercial chicken product (Sysco Strips) serves as positive control. Daring chicken product produced by high moisture extrusion (HME) are 3-fold tougher than commercial chicken. Gardein filet are formed without extrusion showing 2-fold lower mechanical bite. Future Meat Technologies (FMT) chicken produced with low temperature extrusion, with or without egg albumin, show comparable bite to farmed-chicken.

1.-75. (canceled)

76. An isotropic material composition comprising non-animal derived arachidonic acid (ARA) and a Maillard reaction intensifier comprising at least one isolated amino acids and at least one reducing sugar.

77. The composition according to claim 76, further comprising 2-methyl-3-furanthiol.

78. The composition according to claim 76, comprising an oil comprising ARA, protein fibers and a Maillard reaction intensifier selected from isolated amino acids and reducing sugars.

79. The composition according to claim 76 comprising at least one textured plant or fungi protein and at least one non-textured protein.

80. The composition according to claim 76, wherein the at least one reducing sugar is selected from glucose (dextrose), fructose (levulose), galactose, xylose and ribose.

81. The composition according to claim 79, wherein the textured protein is a dehydrated or non-dehydrated protein material.

82. The composition according to claim 81, wherein the textured protein is a textured vegetable protein (TVP).

83. The composition according to claim 82, wherein the TVP is a textured soy protein (TSP), soy meat, or soya chunks.

84. The composition according to claim 79, wherein the textured protein is a textured plant or fungi protein.

85. The composition according to claim 79, wherein the non-textured protein is cultured animal cells.

86. The composition according to claim 76, comprising:
a non-animal derived arachidonic acid;
at least one isolated amino acid or a combination comprising two or more isolated amino acids;
at reducing sugar;
a textured protein, being optionally a plant or fungi protein;
a non-textured protein selected from egg protein, plant protein and cultured chicken cells; and
at least one additive.

87. The composition according to claim 76, comprising:
a non-animal derived arachidonic acid, in an amount of at least 0.05 ppm or in an amount ranging between 0.05 and 10 ppm;
at least one isolated amino acid or a combination of two or more isolated amino acids; wherein the amount of the isolated amino acid or combination ranging between 0.01 and 0.09 wt %;
at least one reducing agent in an amount between 0.01 and 0.1 wt %;
a textured protein, being a plant or fungi protein, in an amount between 10 to 25 wt %;
a non-textured protein selected from egg protein, plant protein and cultured chicken cells, in an amount of between 5 and 30 wt %; and
at least one additive.

88. The composition according to claim 76, comprising:
a non-animal derived arachidonic acid;
cysteine and lysine;
ribose;
a textured protein, being optionally a plant or fungi protein;
a non-textured protein derived from cultured chicken cells; and
optionally 2-methyl-3-furanthiol.

89. A material composition for use in forming a chicken-like meat product, the material composition comprising:
a non-animal derived arachidonic acid;
cysteine and lysine;
ribose;
a textured protein, being optionally a plant or fungi protein;
a non-textured protein derived from cultured chicken cells; and
optionally 2-methyl-3-furanthiol.

90. A poultry-like meat product comprising a composition according to claim 76.

91. A method of manufacturing a poultry-like food product, the method comprising obtaining a material composition according to claim 76 and forming the poultry-like food product under conditions permitting isotropic distribution of protein fibers contained in said material composition.

92. The method according to claim 91, the method comprising
heating the emulsion/oleogel to obtain a gelled product and extruding the gelled product to produce a raw poultry-like product, wherein the raw product contains fibers aligned in multiple directions creating an isotropic bite.

93. A method for forming a poultry-like food product, the method comprising
combining a textured plant or fungi protein, arachidonic acid, 2-methyl-3-furanthiol, a Maillard reaction strengthener and a gelled product formed of a plant oil with a gelling agent and a non-textured protein; and
extruding the gelled product to produce a raw poultry-like product, wherein the product contains fibers aligned in multiple directions.

94. An isotropic chicken-like meat product formed by low temperature extrusion of a composition comprising:
a non-animal derived arachidonic acid;
at least one isolated amino acid or a combination comprising two or more isolated amino acids;
at reducing sugar;
a textured protein, being optionally a plant or fungi protein;
a non-textured protein selected from egg protein, plant protein and cultured chicken cells; and
at least one additive.

95. A grilled or cooked chicken-like meat product formed by grilling or cooking an extrudate comprising:
a non-animal derived arachidonic acid;
at least one isolated amino acid or a combination comprising two or more isolated amino acids;
at reducing sugar;
a textured protein, being optionally a plant or fungi protein;
a non-textured protein selected from egg protein, plant protein and cultured chicken cells; and
at least one additive.
